(19) United States
(12) Patent Application Publication
(10) Pub. No.: US 2019/0133851 A1
(43) Pub. Date: May 9, 2019

(54) PASSENGER ASSISTANCE SYSTEMS FOR ELEVATORS

(71) Applicant: Otis Elevator Company, Farmington, CT (US)

(72) Inventor: Quentin Bezault, Gien (FR)

(21) Appl. No.: 16/172,981

(22) Filed: Oct. 29, 2018

(30) Foreign Application Priority Data
Nov. 3, 2017 (EP) 17306525.1

(51) Int. Cl. A61G 3/02; B66B 1/46; B66B 3/00

(52) U.S. Cl. CPC A61G 3/02; B66B 3/006; B66B 3/004; B66B 1/468

(57) ABSTRACT

Methods and systems for controlling an elevator system including receiving, at a controller of the elevator system, an assisted service request, conveying an elevator car to a landing indicated by the assisted service request, the elevator car defining a passenger space, and activating at least one illuminated indication zone to indicate an assistance region within the passenger space.

### BACKGROUND

The subject matter disclosed herein generally relates to car operating panels of elevator systems and, more particularly, to passenger assistance methods and systems for elevators.

Elevator systems, and particularly elevator cars, are arranged to convey passengers within a building. Persons with disabilities, such as in wheelchairs, may have difficulties using such systems, particularly when an elevator car is filled with other passengers already. Accordingly, improved elevator systems to enable improved experiences for passenger, particularly those that have disabilities, may be desirable.

### SUMMARY

According to some embodiments, methods of controlling elevator systems are provided. The methods include receiving, at a controller of the elevator system, an assisted service request, conveying an elevator car to a landing indicated by the assisted service request, the elevator car defining a passenger space, and activating at least one illuminated indication zone to indicate an assistance region within the passenger space.

In addition to one or more of the features described above, or as an alternative, further embodiments of the methods may include that the at least one illuminated indication zone is located adjacent a car operating panel of the elevator car.

In addition to one or more of the features described above, or as an alternative, further embodiments of the methods may include that the at least one illuminated indication zone is formed by at least one of a projected light, a projected image, and an illuminating panel of the elevator car.

In addition to one or more of the features described above, or as an alternative, further embodiments of the methods may include that the assisted service request is received from an assisted service request panel located at the landing indicated by the assisted service request.

In addition to one or more of the features described above, or as an alternative, further embodiments of the methods may include dispatching an assistance robot from the elevator car to aid a passenger to load into the elevator at a location of the at least one illuminated indication zone.

In addition to one or more of the features described above, or as an alternative, further embodiments of the methods may include generating an audio notification when the at least one illuminated indication zone is activated.

According to some embodiments, elevator systems are provided. The elevator systems include a controller configured to control operation of an elevator car within an elevator shaft; the elevator car defining a passenger space, wherein the controller is configured to perform an assisted service operation upon receipt of an assisted service request and at least one illuminated indication zone arranged to indicate an assistance region within the passenger space, wherein activation of the at least one illuminated indication zone is performed during the assisted service operation.

In addition to one or more of the features described above, or as an alternative, further embodiments of the elevator system may include an assisted service request panel located at a landing of the elevator system, wherein operation of the assisted service panel activates the assisted service operation.

In addition to one or more of the features described above, or as an alternative, further embodiments of the elevator system may include that the assisted service request panel includes an authentication device configured to enable operation of the assisted service request panel to make an assisted service request.

In addition to one or more of the features described above, or as an alternative, further embodiments of the elevator system may include that the authentication device is a device reader configured to detect an authorized device in proximity to the authentication device to enable operation of the assisted service request panel.

In addition to one or more of the features described above, or as an alternative, further embodiments of the elevator system may include that the authentication device comprises a keypad arranged to receive input to enable operation of the assisted service request panel.

In addition to one or more of the features described above, or as an alternative, further embodiments of the elevator system may include an assistance robot located within the elevator car and arranged to aid a passenger in at least one of entering and exiting the elevator car.

In addition to one or more of the features described above, or as an alternative, further embodiments of the elevator system may include that the assistance robot is housed in a storage compartment that is part of the elevator car.

In addition to one or more of the features described above, or as an alternative, further embodiments of the elevator system may include that the assistance robot is configured to operate during the assisted service operation.

In addition to one or more of the features described above, or as an alternative, further embodiments of the elevator system may include at least one of a projector and an illuminating panel in the elevator car arranged to generate the at least one illuminated indication zone.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of an elevator car that may incorporate features of the present disclosure;

FIG. 3 is a schematic illustration of an elevator system that can incorporate embodiments of the present disclosure;

FIG. 4A is a schematic illustration of an elevator system in accordance with an embodiment of the present disclosure;

FIG. 4B is a schematic illustration of the elevator system of FIG. 4A, illustrating open elevator car and landing doors;

FIG. 5A is a schematic illustration of an elevator system in accordance with an embodiment of the present disclosure having an assistance robot;

FIG. 5B is a schematic illustration of the system of FIG. 5A illustrating the assistance robot moving to aid a passenger;

FIG. 5C is a schematic illustration of the system of FIG. 5A illustrating the assistance robot engaging with a passenger;

FIG. 5D is a schematic illustration of the system of FIG. 5A illustrating the assistance robot moving the passenger into the elevator car;

FIG. 6A is a top-down schematic illustration of an elevator system in accordance with an embodiment of the present disclosure;

FIG. 6B is an elevation schematic view of an assistance robot stored in an elevator car and its related support systems; and

FIG. 7 is a flow process for operating an elevator car in accordance with an embodiment of the present disclosure.

### DETAILED DESCRIPTION

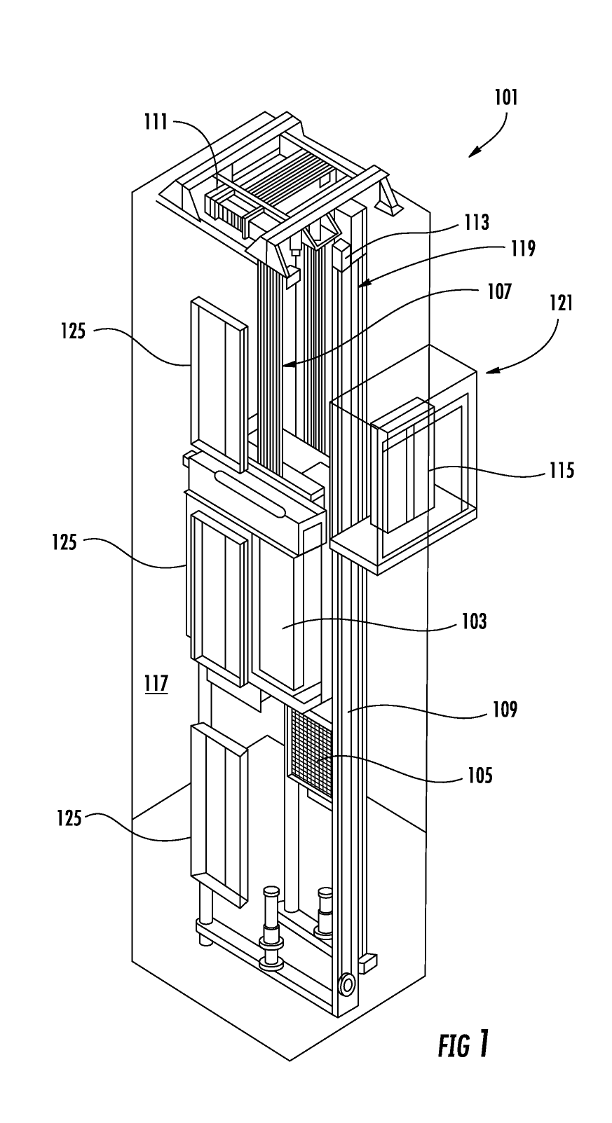

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

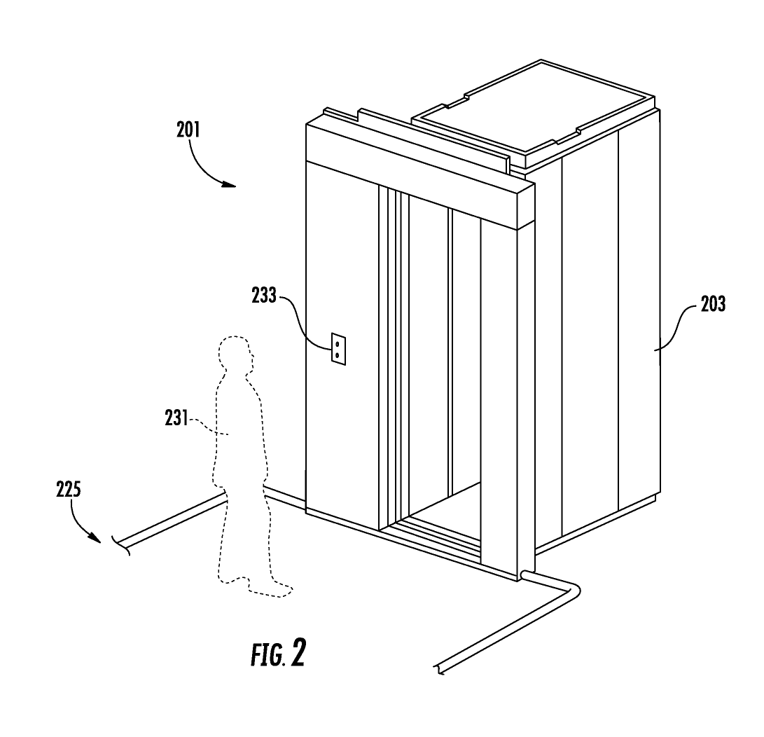

Turning to FIG. 2, schematic illustrations of an elevator system 201 having an elevator car 203 that may employ embodiments described herein are shown. FIG. 2 is a schematic illustration of the elevator car 203 as viewed from a landing 225. A passenger 231 may call the elevator car 203 using a hall call panel 233. Upon arrival of the elevator car 203 at the landing 225, the passenger 231 may enter the elevator car 203 and attempt to access or reach a car operating panel (as shown in FIG. 3) to select a desired destination floor.

Turning now to FIG. 3, a schematic illustration of an elevator car system 300 that can incorporate embodiments of the present disclosure is shown. FIG. 3 illustrates a car operating panel 302 located within the elevator car 303. The elevator car 303 is relatively crowded as illustrated by the number of already present passengers 331a. In the illustration of FIG. 3, a new passenger 331b is shown outside the elevator car 303 (e.g., on a landing floor). When the new passenger 331b enters the elevator car 303, the new passenger 331b may have trouble finding sufficient room or space within the elevator car and/or to access the car operating panel 302. Such difficulty may occur especially for handicapped persons, such as with crutches or in a wheelchair. However, because the elevator car 303 is equipped with an embodiment of the present disclosure, a display device can project a space indication and/or provide an announcement to the passengers 331a within the elevator car 303 that a person will be entering the elevator car 303 and may require additional space for ease of entry into the elevator car 303.

As noted, a problem may arise when a person in a wheelchair or with crutches wants to enter into a crowded elevator car. Embodiments provided herein are directed to aiding persons with disabilities with entering an elevator car. For example, in some embodiments, when a person with disabilities pushes an assisted service request button at a landing floor or makes an assisted service request (e.g., by dongle, mobile device, internet request, et.), an illuminated indication zone can be illuminated on the floor and/or wall panels of the elevator car prior to arrival at the landing floor where the request is made (or where the passenger is waiting). In some embodiments, the illuminated indication zone is located adjacent to a car operating panel to enable easy access to the car operating panel by the disabled passenger. The illuminated indication zone will provide notification to passengers within the elevator car that a disabled person will be entering the car and provide an outline or indication of the amount of space to be needed, e.g., notifying the current passengers to move and make space. Further, in some embodiments, as the elevator car approaches the landing with the disabled person, a voice or audio message can be played within the elevator car to provide audio indication that the illuminated indication zone should be cleared for the new passenger.

Further, in some non-limiting embodiments, an assistance system can be present within the elevator car that provides active assistance to the disabled person. For example, when the elevator car arrives at the landing floor, an assistance robot can exit a storage compartment (e.g. a hidden closet, cabinet, etc.) that is within or part of the elevator car. The assistance robot is configured to travel out of the elevator car, engage with the wheelchair of the disabled person, and subsequently guide, pull, maneuver or otherwise assist the disabled person with loading and entering into the elevator car and position such person at the location of the illuminated indication zone. During such assisted operation, the elevator car doors will remain open, with the assisted service request triggering an extended car door opening operation. In some embodiments, the assistance robot may return to the storage compartment after aiding the wheelchair-bound person into the elevator car. In other embodiments, the assistance robot may remain with or near the wheelchair-bound person within the elevator car. After the wheelchair-bound person has entered the elevator car, the illuminated indication zone can disappear and the other passengers in the elevator car can move to have more room.

In some embodiments, when the elevator car arrives on the destination floor where a person with disabilities intends to exit, the illuminated indication zone will appear again, optionally with an audio message. The assistance robot will then aid the person with disabilities out of the elevator car. Subsequently, the assistance robot will return to the storage compartment. The destination floor can be pre-programmed through the assisted service request made at the landing where the original service request was input, e.g., with additional destination buttons present at the assisted service request button. Alternatively, the entered destination floor that is input at a car operating panel during the assisted service operation can be set as the destination floor of the person with disabilities. Further, still, if the assisted service request is made by a remote system (e.g., mobile device, internet-based request, etc.), the destination floor can be input by the requestor at such time that the assisted service request is made.

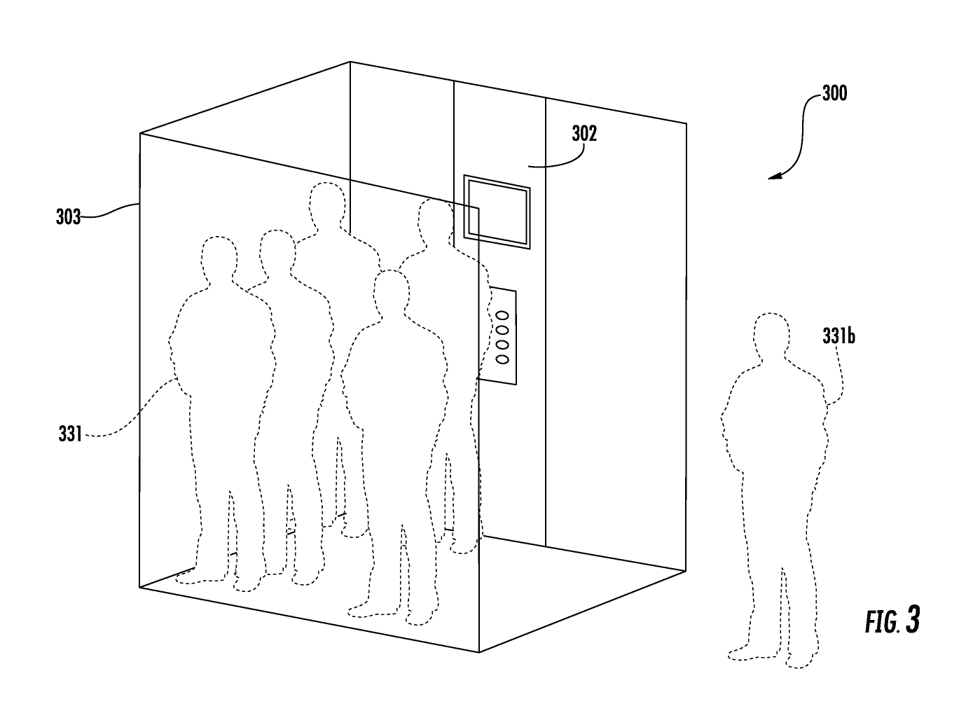

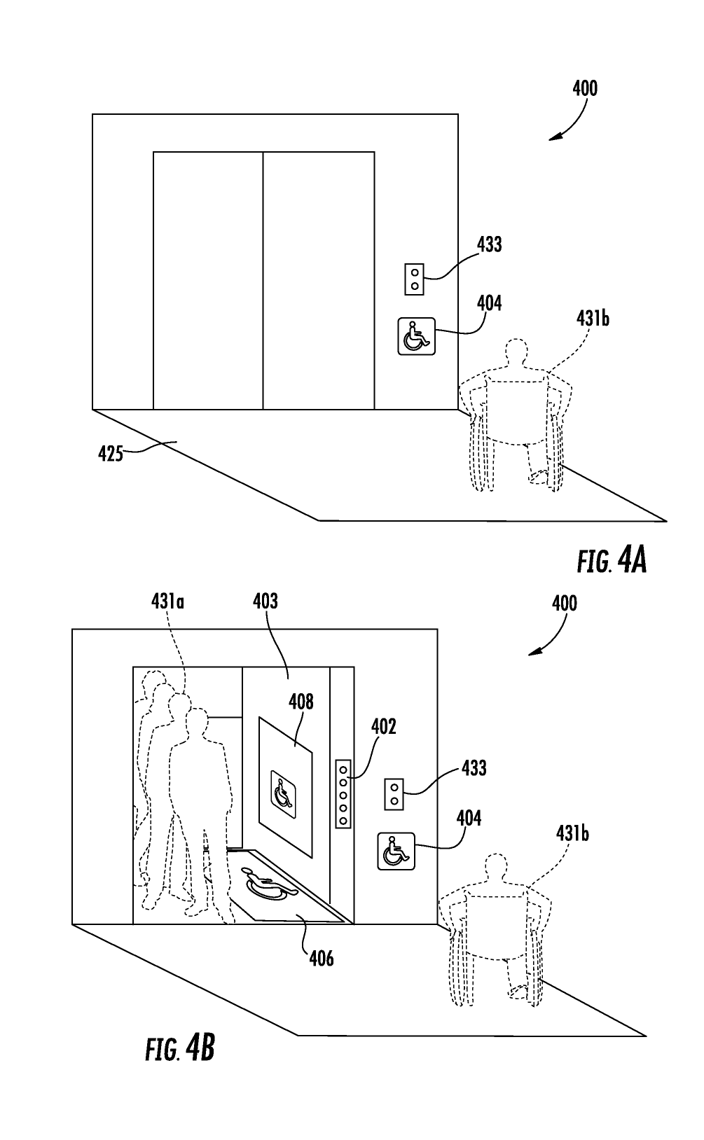

Turning now to FIGS. 4A-4B, schematic illustrations of an elevator system 400 in accordance with an embodiment of the present disclosure are shown. FIG. 4A illustrates a new passenger 431b who is wheelchair-bound and located at a landing 425. The new passenger 431b may wish to request elevator service of the elevator system 400. To make a request, the new passenger 431b can operate or use a hall call panel 433, e.g., a typical up/down arrow hall call panel. However, such operation may not enable already present passengers 431a located in an elevator car 403 (shown in FIG. 4B) to prepare for the new passenger 431b, who is disabled, to enter the elevator car 403. However, the elevator system 400 includes an assisted service request panel 404 located at the landing 425.

The assisted service request panel 404 can include a special request button and, optionally, additional buttons for enabling a user of the assisted service request panel 404 to input destination floors or to receive other input. For example, in some embodiments, the assisted service request panel 404 can include an authentication device, such as a badge reader, that enables only selective access of the assisted service request panel 404 when an authorized device, e.g., a badge, has been detected in proximity thereto. In some embodiments, the assisted service request panel 404 can include a keypad or similar system to enable code or password input to enable access and use of the assisted service request panel 404. In some embodiments, the assisted service request may be made remotely (e.g., through a mobile device or internet-based system) and the assisted service request panel 404 may be omitted or modified to work with such system.

When an assisted service request is made at the assisted service request panel 404, the elevator car 403 will travel to the requesting landing 425 to enable the new passenger 431b to enter the elevator car 403, such as shown in FIG. 4B. As shown in FIG. 4B, the elevator car 403 includes multiple illuminated indication zones that are projected images or light that are displayed on surfaces of the interior of the elevator car 403. For example, as shown, a first illuminated indication zone 406 is projected onto a floor of the elevator car 403 and a second illuminated indication zone 408 is projected onto a wall panel of the elevator car 403. Both the first and second illuminated indication zones 406, 408 are arranged to indicate sufficient space or volume to allow a person in a wheelchair to move into the elevator car 403. The illuminated indication zones 406, 408 are projected at positions adjacent a car operating panel 402 of the elevator car 403. Accordingly, when the new passenger 431b enters the elevator car 403, the new passenger 431b will be positioned adjacent the car operating panel 402 and have easy access thereto.

The illuminated indication zones 406, 408 may be generated when the assisted service request is made, or may be generated when the elevator car 403 approaches the landing 425 at which the assisted service request was made. Accordingly, the projected images of the illuminated indication zones 406, 408 are present prior to the elevator car 403 stopping at the landing 425 and prior to the elevator car doors opening at the landing 425. When the illuminated indication zones 406, 408 are generated, an accompanying audio recording or audio notification can also be generated within the elevator car 403 such that the already present passengers 431a will be alerted to the new passenger 431b intending to board or enter the elevator car 403.

The illuminated indication zones 406, 408 are projected images or light, and thus can be generated by lights, projectors, or other components as will be appreciated by those of skill in the art. Further, the audio notifications associated with the generation of the illuminated indication zones 406, 408 can be projected from one or more speakers located within the elevator car 403. In some embodiments, instead of being projected, one or both of the illuminated indication zones 406, 408 may be backlit or otherwise may be light-up panels of the elevator car 403. That is, the illuminated indication zones 406, 408 may be identified by illuminating panel(s) of the elevator car 403.

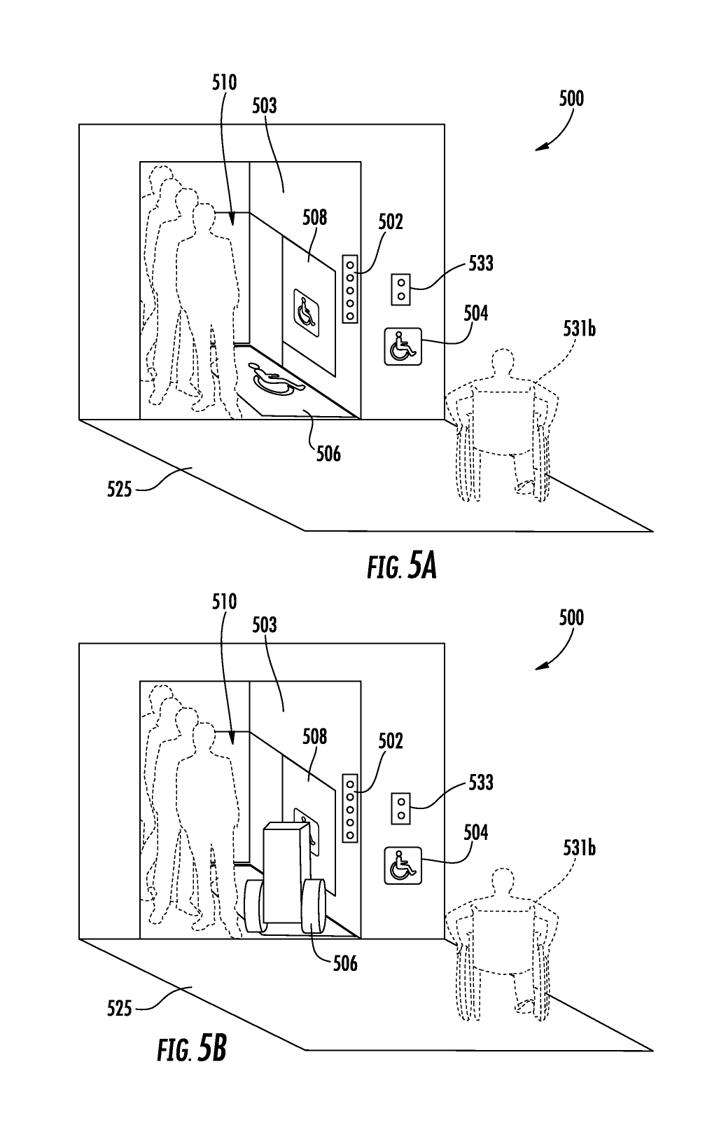

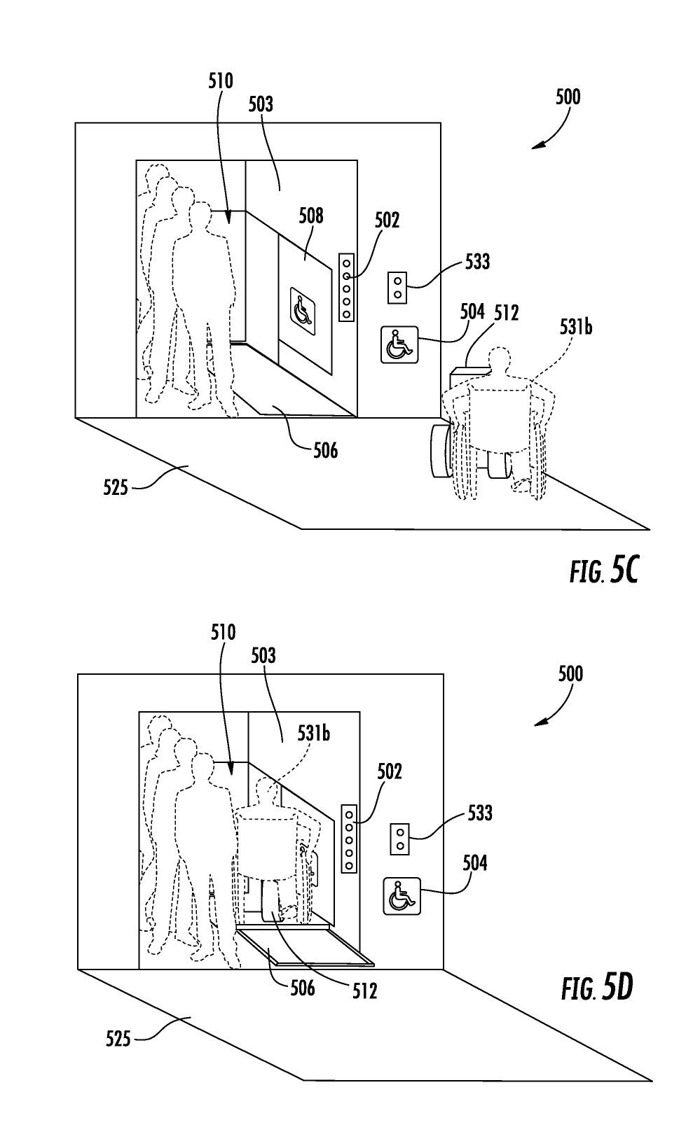

Turning now to FIGS. 5A-5D, schematic illustrations of an elevator system 500 in accordance with an embodiment of the present disclosure are shown. The elevator system 500 is similar to that shown in FIGS. 4A-4B, with and elevator car 503 having a car operating panel 502 that provides service to a landing 525. As shown, at the landing 525, a hall call panel 533 and an assisted service request panel 504 are located adjacent landing doors of the landing 525. The hall call panel 533 and the assisted service request panel 504 are operable and interactive to enable a new passenger 531b to make an elevator service request, as described above. The elevator car 503 includes a system to generate first and second illuminated indication zones 506, 508, similar to that shown and described above. Further the elevator car 503 can include speakers for providing audio notification of the imminent boarding of a person making an assisted service request.

In this embodiment, the elevator car 503 includes a storage compartment 510 that is part of the elevator car 503. The storage compartment 510 is a storage space with a door or similar opening that houses an assistance robot 512 (shown in FIG. 5B). In this embodiment, in addition to indicating a space for the new passenger 531b to occupy once in the elevator car 503, one or both of the first and second illuminated indication zones 506, 508 can indicate a necessity to move to allow a door or other opening of the storage compartment 510 to open and thus allow the assistance robot 512 to move within and through the elevator car 503.

Once the elevator car 503 arrives at the landing 525, the assistance robot 512 can move to assist the new passenger 531b to enter the elevator car. In some embodiments, the assistance robot 512 may only leave the storage compartment 510 when the elevator car doors and landing doors open. FIG. 5B illustrates the assistance robot 512 moving through the elevator car 503 and onto the landing 525 to engage with or otherwise aid the new passenger 531b with entering the elevator car 503. FIG. 5C illustrates the assistance robot 512 located on the landing 525 and engaged with the new passenger 531b. FIG. 5D illustrates the new passenger 531b as boarded onto the elevator car 502, with the assistance robot 512 positioned to provide assisted exiting for the new passenger 531b when the destination floor is reached.

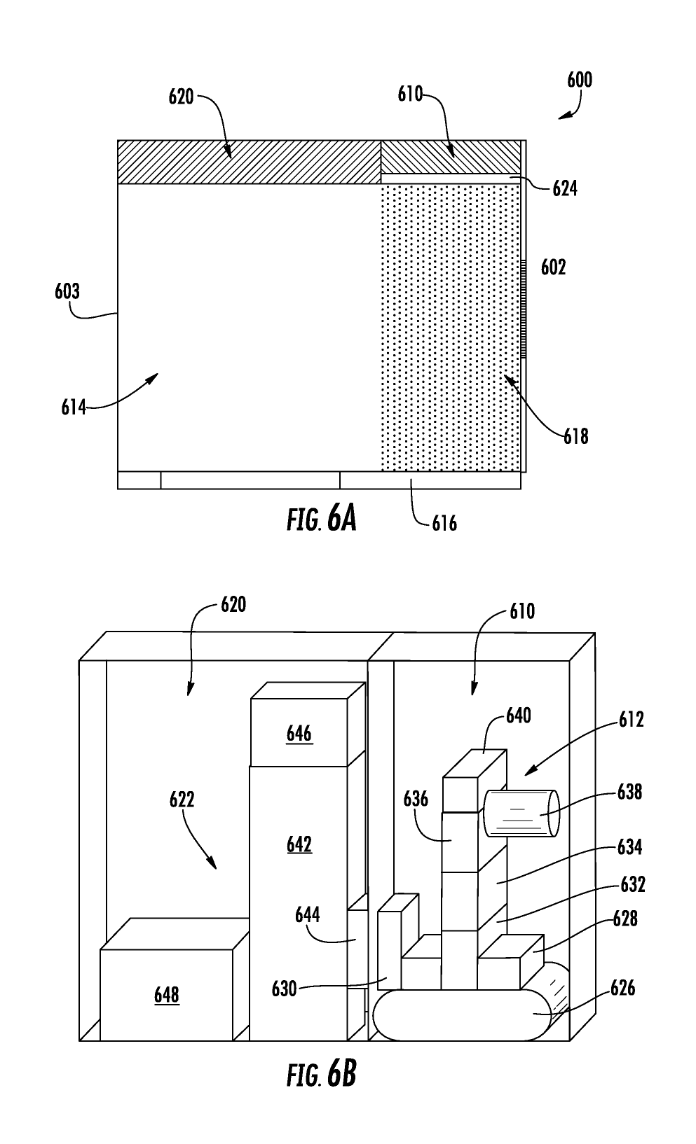

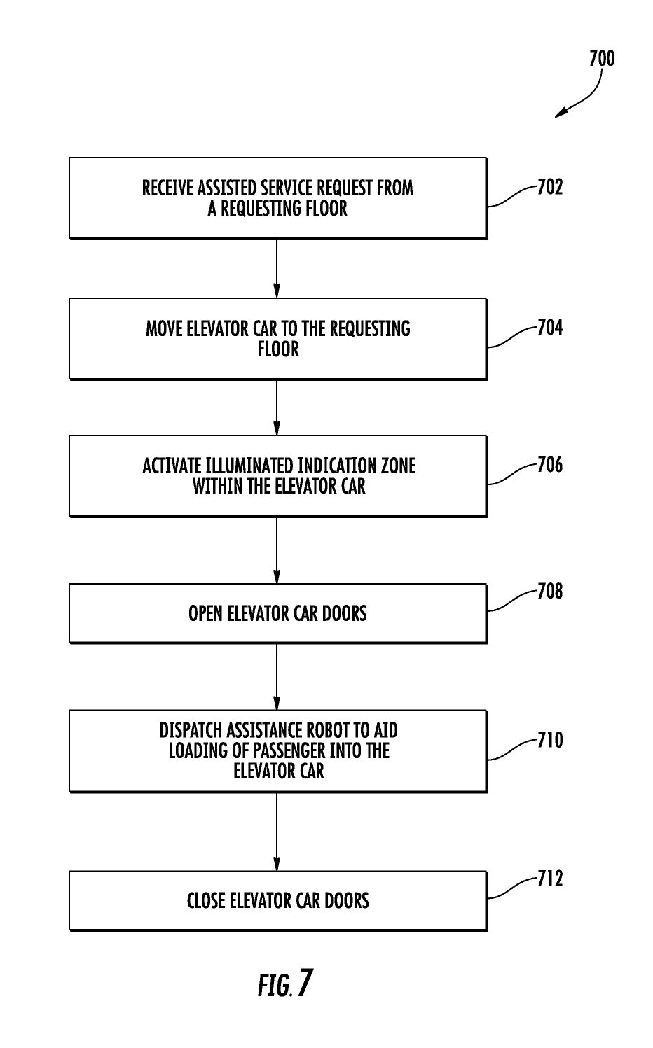

Turning now to FIGS. 6A-6B, schematic illustrations of an elevator system 600 in accordance with an embodiment of the present disclosure are shown. FIG. 6A is a top-down illustration of an elevator car 603 arranged to house an assistance robot similar to that described with respect to the elevator system 500 (FIGS. 5A-5D). FIG. 6B is an elevation view of a part of the elevator car 603. As shown, the elevator car 603 includes a passenger space 614 that is defined, in part, by openable elevator car doors 616. The elevator car 603 includes a car operating panel 602.

The elevator car 603 is arranged to enable passenger assistance as described above. As shown, the passenger space 614 includes an assistance region 618. The assistance region 618 can be indicated by one or more illuminated indication zones, as described above. As shown, the assistance region 618 of the passenger space 614 is located adjacent a wall of the elevator car 603 having the car operating panel 602.

The elevator car 603 further includes an assistance robot 612 (shown in FIG. 6B) that is housed within a storage compartment 610. Adjacent the storage compartment 610, in this embodiment, is an assistance control compartment 620 which houses control elements 622 for the assistance robot 612. The storage compartment 610 includes an openable panel 624 that forms an elevator car panel defining a part of the passenger space 614 when the openable panel 624 is closed. For example, the openable panel 624 can be a vertical or horizontal sliding door, multiple doors/panels, etc. that form a wall or panel of the elevator car. However, when a request for assisted service is made, and the elevator car 603 arrives at a landing where such request was made, the openable panel 624 may open to allow the assistance robot 612 to perform an assistance operation, as described above.

As shown in FIG. 6B, an illustrative example of an arrangement for housing the assistance robot 612 is shown. The assistance robot 612 includes a conveyance mechanism 626 (e.g., treads, wheels, legs, etc.) for enabling movement of the assistance robot 612 out of the storage compartment 610 and into the assistance region 618 (e.g., part of the passenger space 614) of the elevator car 603. The assistance robot 612 includes one or more power sources 628, a first charging component 630, a driving component 632, an electronics component 634, and an adjusting element 636. The adjusting element 636 is arranged to adjust a height of a portion of the assistance robot 612, such as an engaging arm 638 that is arranged to enable engagement with a wheelchair. In some embodiments, the engaging arm 638 is formed so that it can operate or function as a handle that a person with a disability (e.g., in a wheelchair, walking with crutches, etc.) can hold onto to aid in entering the elevator car 603 by the assistance robot 612 (e.g., passive assistance handle/arm). In some embodiments, the engaging arm 638 can be an active element that includes a robotic or actuating arm/hand that can engage and/or latch onto a wheelchair to enable the assistance robot 612 to pull or push the wheelchair into the elevator car 603. The assistance robot 612 further includes a guidance system 640. The guidance system 640 can include electronics, processors, imaging devices, etc. to enable proper movement from the storage compartment 610, into and through the assistance region 618 of the elevator car 603, and onto a landing, as described above.

The assistance robot 612 can be pre-programmed, or can be controlled by one or more control elements 622 housed in the assistance control compartment 620. The control elements 622 can include a charging system 642 having a second charging component 644 that is arranged to enable charging of the first charging component 630 and the power sources 628 of the assistance robot 612. The control elements 622 can further include a control unit 646. The control unit 646 can be a computer or other processing and/or control device arranged in communication with the guidance system 640 (or other parts) of the assistance robot 612. Also shown in FIG. 6B, a maintenance box 648 is located within the assistance control compartment 620. The maintenance box 648 can hold various components, replacement parts, tools, etc. that are stored for use by a technician to perform maintenance on the assistance robot 612.

Turning now to FIG. 7, a non-limiting flow process 700 for operating an elevator system in accordance with an embodiment of the present disclosure is shown. The flow process 700 can be a processing logic and control that is implemented in one or more controllers or control units, as described above (e.g., elevator machine, guidance system, etc.). Flow process 700 is used to provide assistance to passengers of elevator systems who may have trouble entering and/or exiting an elevator car.

At block 702, a request for assisted service is received at a controller or control unit of the elevator system. The request can be made by a user located at a landing and/or by a passenger intending to be at a landing in the future. For example, in some embodiments, a special request button can be provided on an assisted service request panel located at a landing of the elevator system. In some embodiments, the assisted service request panel can include additional buttons for enabling a user of the assisted service request panel to input destination floors or to receive other input. Further, in some embodiments, the assisted service request panel can include a badge reader that enables only selective access of the assisted service request panel when a badge has been detected in proximity thereto. In some embodiments, the assisted service request panel can include a keypad or similar system to enable code or password input to enable access and use of the assisted service request panel. In some embodiments, the assisted service request may be made remotely (e.g., through a mobile device or internet-based system) and the assisted service request panel may be omitted or modified to work with such system.

At block 704, an elevator machine conveys an elevator car to the landing where an assisted service request has been made.

At block 706, as the elevator car approaches the landing where the assisted service request was made, one or more illuminated indication zones can be activated to indicate a space that should be cleared to enable a disabled person to enter the elevator car and/or to enable an assistance robot to move freely through the elevator car to provide assistance to the disabled person. The illuminated indication zones can be generated by projection and/or lighting of panels in the elevator car, as described above. Any number of illuminated indication zones can be present in the elevator car, and although two illuminated indication zones are illustrated above, those of skill in the art will appreciate the number, location, and geometry of the illuminated indication zones can be varied without departing from the scope of the present disclosure. Further, in some embodiments, additional illuminations and/or audio notification(s) can be generated when the illuminated indication zones are activated to provide notice and warning to passengers located in the elevator car.

At block 708, when the elevator car reaches the landing, the elevator car doors will be opened.

At block 710, optionally, when an elevator is equipped with an assistance robot, the assistance robot can be dispatched to aid the requesting passenger (e.g., disabled person) in entering the elevator car. However, in an embodiment where the assistance robot is not included, block 710 can be omitted.

At block 712, the elevator car doors will close, such as when the disabled person has loaded onto the elevator car. In embodiments having an assistance robot, the elevator car doors may close once the assistance robot is located in a designated location within the elevator car, which can indicate that the disabled person is sufficiently within the elevator car to enable clearance for closing of the elevator car doors.

Embodiments of the flow process 700 can include various subroutines associated with assisted service requests to provide additional efficiencies to the system. For example, the system/process can include detection and/or determination regarding available free space to accommodate a wheelchair within the elevator car. In such process, a sensor mounted into the elevator car can detect if there is sufficient space to contain a wheelchair. Such sensor can include processing equipment to perform detection and approximation of an amount of free space within an elevator car. The sensor can include optical cameras or detectors, proximity detectors, pressure/location sensors, etc. that are able to individually or collectively measure an amount of free space in an elevator car. Based on the amount of detected free space, a determination can be made whether the flow process 700 should be performed with the specific elevator car. The processing can compare a detected or measured amount of free space against a predetermined minimum requirement of free space to enable the flow process 700 to continue. If sufficient free space is detected, the flow process 700 can be performed. However, if insufficient free space is detected, the flow process 700 can wait until a sufficient amount of free space is available such that a wheelchair can enter the elevator car. In some such embodiments, the free space detection can be performed for every elevator car of a multi-elevator car system, to determine the best elevator car to perform the assisted service request. Further, in some such embodiments, if no elevator car is determined to have sufficient free space, the detection of free space can be performed after each landing stop an elevator car performed (e.g., after each instance when current passengers can enter/exit the elevator car).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. A method of controlling an elevator system comprising:
receiving, at a controller of the elevator system, an assisted service request;
conveying an elevator car to a landing indicated by the assisted service request, the elevator car defining a passenger space; and
activating at least one illuminated indication zone to indicate an assistance region within the passenger space.

2. The method of claim 1, wherein the at least one illuminated indication zone is located adjacent a car operating panel of the elevator car.

3. The method of claim 1, wherein the at least one illuminated indication zone is formed by at least one of a projected light, a projected image, and an illuminating panel of the elevator car.

4. The method of claim 1, wherein the assisted service request is received from an assisted service request panel located at the landing indicated by the assisted service request.

5. The method of claim 1, further comprising dispatching an assistance robot from the elevator car to aid a passenger to load into the elevator at a location of the at least one illuminated indication zone.

6. The method of claim 1, further comprising generating an audio notification when the at least one illuminated indication zone is activated.

7. An elevator system comprising:
a controller configured to control operation of an elevator car within an elevator shaft; the elevator car defining a passenger space, wherein the controller is configured to perform an assisted service operation upon receipt of an assisted service request; and
at least one illuminated indication zone arranged to indicate an assistance region within the passenger space, wherein activation of the at least one illuminated indication zone is performed during the assisted service operation.

8. The elevator system of claim 7, further comprising an assisted service request panel located at a landing of the elevator system, wherein operation of the assisted service panel activates the assisted service operation.

9. The elevator system of claim 8, wherein the assisted service request panel includes an authentication device configured to enable operation of the assisted service request panel to make an assisted service request.

10. The elevator system of claim 9, wherein the authentication device is a device reader configured to detect an authorized device in proximity to the authentication device to enable operation of the assisted service request panel.

11. The elevator system of claim 9, wherein the authentication device comprises a keypad arranged to receive input to enable operation of the assisted service request panel.

12. The elevator system of claim 7, further comprising an assistance robot located within the elevator car and arranged to aid a passenger in at least one of entering and exiting the elevator car.

13. The elevator system of claim 12, wherein the assistance robot is housed in a storage compartment that is part of the elevator car.

14. The elevator system of claim 12, wherein the assistance robot is configured to operate during the assisted service operation.

15. The elevator system of claim 7, further comprising at least one of a projector and an illuminating panel in the elevator car arranged to generate the at least one illuminated indication zone.
